(19) United States
(12) Patent Application Publication
(10) Pub. No.: US 2025/0353139 A1
(43) Pub. Date: Nov. 20, 2025

(54) METHOD FOR CLAMPING A TOOL ON A TOOL SPINDLE IN A HARD FINISHING MACHINE AND HARD FINISHING MACHINE

(71) Applicant: KAPP NILES GmbH & Co. KG, Coburg (DE)

(72) Inventors: Sergiy GRINKO, Coburg (DE); Achim STEGNER, Coburg (DE); Nico SCHILLING, Lautertal (DE); Lars LUTHER, Meeder (DE); Holger ARMBORST, Sonneberg (DE); Julian GLEICHMANN, Meeder (DE)

(21) Appl. No.: 19/208,086

(22) Filed: May 14, 2025

(30) Foreign Application Priority Data
May 16, 2024 (DE) 10 2024 113 831.9

(51) Int. Cl. B24B 47/10

(52) U.S. Cl. CPC B24B 47/10

(57) ABSTRACT

A method for clamping a tool on a tool spindle in a hard finishing machine that includes: the tool spindle connected to a drive motor, with a cylindrical receiving seat and a thread, and the tool. The receiving seat is limited at one axial position of the tool spindle by a abutment flange for axial abutment of the tool. A clamping nut can be screwed onto the thread and is designed for axial abutment on the tool. The clamping nut is temporarily held in a rotationally fixed manner when the tool spindle is rotated by the drive motor. The method includes: placing the tool on the receiving seat and screwing the clamping nut onto the thread; blocking the clamping nut against rotation during the rotation of the tool spindle with the drive motor; and actuating the drive motor to tighten the clamping nut so it presses axially against the tool.

### CROSS-REFERENCE TO RELATED APPLICATIONS

The present application claims priority of DE 10 2024 113 831.9, filed May 16, 2024, the priority of this application is hereby claimed, and this application is incorporated herein by reference.

### BACKGROUND OF THE INVENTION

The invention relates to a method for clamping a tool on a tool spindle in a hard finishing machine, wherein the hard finishing machine comprises: a tool spindle connected to a drive motor, with a cylindrical receiving seat and a thread, and a tool, in particular a grinding tool, with a bore for receiving the tool on the receiving seat, wherein the receiving seat is limited at an axial position of the tool spindle by an abutment flange for the direct or indirect axial abutment of the tool, and wherein a clamping nut is screwable onto the thread, which is formed for direct or indirect axial abutment against the tool. Furthermore, the invention relates to a hard finishing machine

In a hard finishing machine of the generic type, in preparation for the machining process, in particular the grinding process, a tool is placed on the tool spindle, for which the tool has a bore that corresponds to a cylindrical seat on the tool spindle. The tool is pushed axially against the abutment flange and then axially fixed or clamped, for example, by screwing a clamping nut onto the thread. Standardized conditions are also specified for this in order to ensure reliable axial clamping of the tool on the tool spindle.

Insofar, it is known that tool arbors are used onto which the grinding tool is mounted. This is then clamped with a centrally located clamping nut, or alternatively with several screws arranged on a pitch circle. In the latter case, the tool must have a metallic base body in which the screw hole pattern is provided. Due to its wall thickness, the usable dressing length of the grinding wheel is partially lost. Another typical design—especially in the case of a solid corundum tool—is face clamping by means of a flange that is screwed to the spindle. In this case, too, the usable dressing length of the grinding tool is lost due to the wall thickness of the flange. In all cases (clamping nut, screws or flange), the generated screw force corresponds to the clamping force with which the grinding wheel is axially clamped. The necessary machining forces and the drive torque can be transmitted through the resulting end face friction between the grinding wheel and the contact surfaces.

In particular, when mounting small grinding worms on corresponding mandrels or spindles, the tightening torque for the clamping nut can sometimes be problematic. To ensure that the tool is seated reliably, relatively large torques usually have to be applied to the clamping nut so that setting amounts (in particular of intermediate rings made of plastic) or machining loads can be absorbed. As a result of settling, the clamping nut may also need to be retightened after a certain period of production.

The disadvantage of the previously known method is that, in particular for internal generative grinding tasks, problems arise due to the fact that relatively small tools have to be used (i.e. in particular small grinding worms), so that the above-described problem occurs to a greater extent. Furthermore, in this case in particular, the correct mounting and clamping of the tool on the tool spindle is labor-intensive and therefore expensive. This applies in particular if the tool is retightened at periodic intervals during the production process in order to ensure that the tool is seated reliably on the spindle.

In particular, when using internal generative grinding, the compact size of the grinding unit does not provide enough space for a metallic base body to mount the grinding disc with screws. Furthermore, the tool change times for loosening and tightening the numerous screws are relatively long. The frequent tool changes of the small corundum discs or corundum worms have a particularly negative effect. Therefore, in accordance with the concept mentioned at the beginning, a centrally mounted face nut (clamping nut) is preferred to build up the clamping force. This can be quickly changed, freely designed and better adapted to the given space conditions. The clamping nut is in contact with the grinding wheel and presses it against the rim of the tool spindle flange.

The grinding wheels used here essentially consist of abrasive grains held together by a binder. This porous structure is susceptible to excessive surface pressure, which can occur in particular below the clamping surfaces when the clamping forces are too high. The resulting tension peaks can cause cracks in the disc structure. If, on the other hand, the clamping forces are too low, the clamping is not able to transfer all the necessary forces and torques. The consequence is that the grinding wheel slips on the disc seat. However, this means that the angular position between the grinding motor and the grinding tool no longer matches and the rolling connection is lost. Thus, both insufficient and excessive clamping forces can cause the grinding wheel to fail. This results in damage to the workpiece and the machine.

A method for tightening and loosening the clamping nut of a grinding wheel is known from JP H08 290 359 A, in which the clamping nut is driven in a rotatable manner by means of a screwdriver. DE 36 44 441 A1 describes a method in which the grinding wheel is clamped by hand when the drive motor of the tool spindle is switched off.

### SUMMARY OF THE INVENTION

It is the object of the invention to develop a method of the type mentioned above and to provide a corresponding hard finishing machine so that sufficient axial tool clamping force can be ensured in a simple manner. Furthermore, it should be possible to considerably simplify the assembly and, in particular, the axial clamping of the tool on the spindle. Finally, the possibility of automated mounting and clamping of the tool on the spindle should be created. In particular, this should make it possible to clamp small tools with a low usable volume reliably and in a simple manner on the tool spindle.

The solution of this object by the invention is characterized according to the method in that the hard finishing machine has further means to temporarily hold the clamping nut in a rotationally fixed manner during the rotation of the tool spindle with the drive motor, wherein the method comprises the steps of:
a) placing the tool on the receiving seat and screwing the clamping nut onto the thread (preferably with a handling system);
b) blocking the clamping nut against rotation by the means, so that the clamping nut is fixed against rotation during the rotation of the tool spindle with the drive motor;
c) actuating the drive motor and thereby tightening the clamping nut so that it presses axially against the tool.

In this way, the tool clamping process can be carried out solely by using the torque of the drive motor of the tool spindle, preferably fully automatically.

Another advantage in this context is that this process can be automated relatively easily, if necessary using suitable handling systems.

Another particularly advantageous feature is that it is possible to repeat the described clamping procedure for the tool at least once during the production process, preferably periodically, with the tool clamped, as further embodiment proposes. This can also be done very quickly and fully automatically.

The generic hard finishing machine provides, according to the invention, that means are also arranged on it to hold the clamping nut temporarily in a rotationally fixed manner when the tool spindle is rotated by the drive motor.

In order to optimally utilize the torque of the drive motor for clamping the tool, the special design of the machine has proven effective, wherein a first ring is arranged axially between the abutment flange and the tool which has a first friction coefficient between itself and the abutment flange, and wherein a second ring is arranged axially between the clamping nut and the tool which has a second friction coefficient between itself and the clamping nut, the first friction coefficient being greater than the second friction coefficient.

The first friction coefficient is preferably at least twice as large as the second friction coefficient. In concrete terms, it can be provided that the first friction coefficient is at least 0.5 and the second friction coefficient is at most 0.15.

The first ring can consist of a base body with a friction-enhancing coating. The friction-enhancing coating can have diamond or boron nitride grains or be formed by these.

The second ring can consist of a base body that is provided with a friction-reducing coating or a material with a low friction coefficient. Especially plastic is contemplated as this material.

A third ring made of plastic can be placed between the first ring and the tool. As a result of the friction-enhancing coating of the first ring, a good torsionally rigid connection can be created with the third ring; the third ring, in turn, can be very well connected in a torsionally rigid manner to the corundum particles of the tool (in the case of a grinding tool) due to its plastic design, so that a high torque can be transmitted from the flange of the tool spindle via the first and third ring to the tool.

A fourth ring, which has acrylonitrile butadiene rubber (NBR) or consists of this material, can be placed between the second ring and the tool.

The third and fourth rings used have a certain degree of spring elasticity due to their plastic composition, so that after tightening the clamping nut, security against subsidence is provided.

The axial clamping, in particular of a ceramic-bonded grinding worm, can be carried out in the proposed design in such a way that the setting amounts due to the (shim) rings, the tool and the clamping elements are in such a ratio to the rigidity that the clamping force is maintained at least 90% despite setting phenomena. This is aided by the aforementioned friction-enhancing coating, which allows a significant increase in the transmissible torques, which is particularly important when the clamping nut is tightened solely by the drive motor of the tool spindle (and thus a reduced axial normal force of the clamping is given, as it is in the case of when the clamping operation is performed manually using a tool).

The resulting reduction in the required tightening torque of the screw-on clamping nut can now be applied particularly effectively by the drive motor of the tool spindle itself. If the clamping nut is provided with a torque support, a tool can be clamped automatically. The tool clamping can thus be retightened automatically and monitored and controlled via the motor currents. This offers an additional possibility to take the setting amounts into account. Retightening the clamping nut can compensate for mechanisms that act over time.

This makes it possible to implement an automatic clamping concept for the tool on the tool spindle and thus to carry out an automatic tool change. The proposed concept has proven particularly useful in connection with internal generative grinding, in which small tools (grinding worms) with a small useful diameter are used without the possibility of shifting in a sensitive bearing. In this case, an automatic tool change is of particular advantage. This applies especially when a dressable grinding tool and particularly a dressable grinding worm with a ceramic-bonded abrasive is used, since a relatively frequent tool change must be carried out here.

Thus, in accordance with the proposed method and the proposed design of the machine, a concept for automatic clamping of the rotating tool is provided, whereby the torque or clamping force required for clamping is applied to the clamping nut exclusively by the drive motor of the tool spindle. During the clamping process, the clamping nut is prevented from rotating and the motor is activated so that the clamping nut is screwed onto the thread of the tool spindle with sufficient torque.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

FIG. 1 shows a perspective view of a grinding arm on which a tool in the form of a grinding wheel is clamped,

FIG. 2 shows a perspective view of the grinding arm as shown in FIG. 1, with the means for holding the clamping nut in a fixed position for clamping the tool, i.e. the clamping process of the tool by using the drive torque of the drive motor of the tool spindle is shown,

FIG. 3 shows an exploded view of the grinding arm according to FIG. 2 and

FIG. 4 shows the radial section through the tool spindle, indicating the path of the applied and transmitted forces.

### DETAILED DESCRIPTION OF THE INVENTION

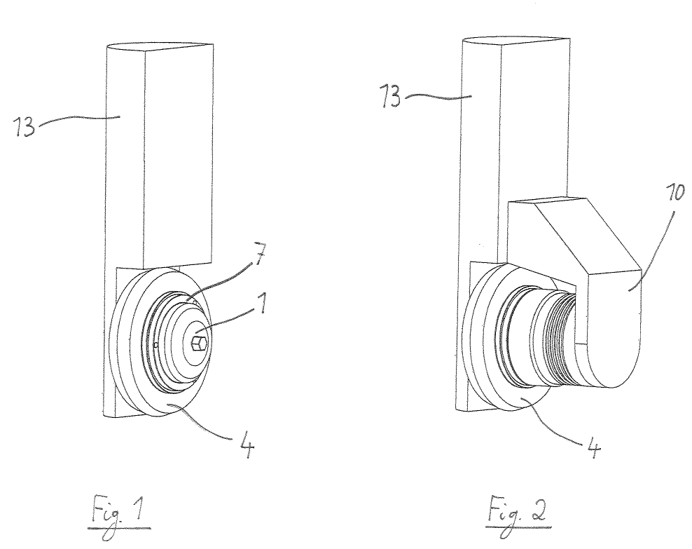

FIG. 1 shows a rod-shaped grinding arm 13, which has a tool spindle 1 at its lower axial end, which is driven by a drive motor that is not shown. The drive motor can, for example, be arranged above the grinding arm 13 and transmit its torque to the tool spindle 1 via a belt drive; however, another drive is of course also possible, for example a direct drive of the tool spindle (with the drive motor arranged directly on the spindle).

The tool spindle 1 carries a tool 4 in the form of an abrasive grinding worm. The tool 4 is fastened on the tool spindle 1 by means of a clamping nut 7.

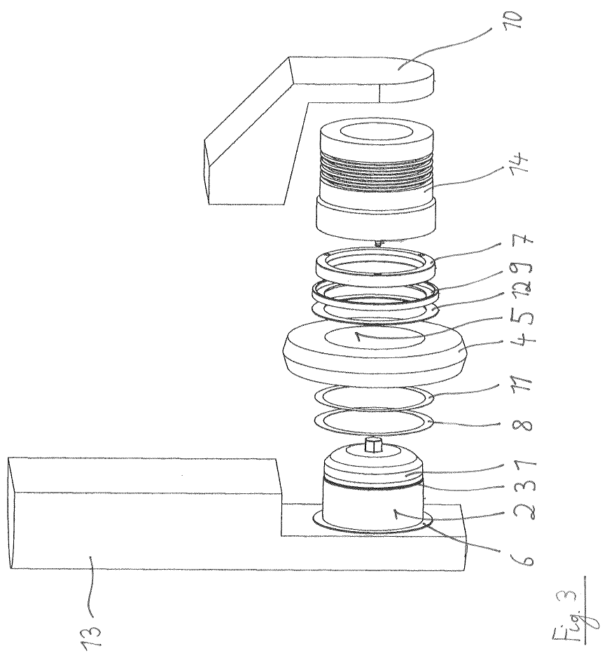

As can be seen from the following explanations, the design of the arrangement is such that it is possible to clamp the tool 4 on the tool spindle 1 solely by means of the torque of the drive motor (not shown) of the tool spindle 1, i.e. to tighten the clamping nut 7. To do this, the clamping nut 7 is prevented from turning by means of a counterholder 10 (means of holding the clamping nut 7 against rotation) —as shown in FIG. 2; at the same time, the drive motor is activated and the clamping nut 7 is tightened in this way. A bellows coupling 14 is also shown, which is arranged between the counterholder 10 and the clamping nut 7.

However, the counterholder 10 can also be designed as a separate element, which is arranged in the machine and, when needed, is moved from a resting position to the clamping nut 7 to block its rotation.

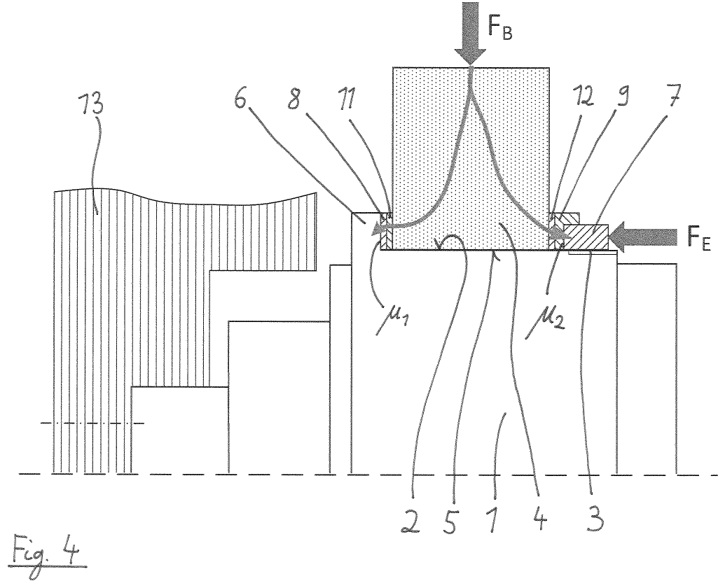

As far as the specific design of the means 10 is concerned, there are a variety of options. One favorable option is to provide the means 10 with a plurality of projections or pins extending in the axial direction, which engage in corresponding recesses or holes in the clamping nut 7 (this can be seen in FIG. 1 and in FIG. 3, where three recesses are provided in the clamping nut 7, distributed around the circumference). This prevents the clamping nut 7 from turning when the means 10 engage.

The exact structure of the arrangement, which results from a preferred embodiment of the invention, is shown in FIG. 3.

The illustration shows the tool spindle 1 with its cylindrical receiving seat 2 for the tool 4. Tool 4 has a bore 5 that is tolerated to the receiving seat 2. Tool spindle 1 has a thread 3 for the clamping nut 7 and an abutment flange 6 for axial contact with tool 4.

It is relevant that a first ring 8 is arranged axially between the contact flange 6 and the tool 4. This has a first friction coefficient μ₁ between itself and the abutment flange 6. Furthermore, a second ring 9 is arranged axially between the clamping nut 7 and the tool 4. This has a second friction coefficient μ₂ between itself and the clamping nut 7. It is essential that the first friction coefficient μ₁ is greater than the second friction coefficient μ₂.

On the one hand, this ensures that a relatively high torque can be transmitted between tool 4 and flange 6 due to the high friction coefficient μ₁, which is essential for the operation of the system. On the other hand, the low friction coefficient μ₂ ensures that when the clamping nut 7 is tightened, a relatively high axial force can be generated solely by the torque of the drive motor of the tool spindle 1, which presses the tool 4 against the flange 6, which is a prerequisite for a safe torque transmission from the tool spindle to the tool.

For this purpose, it is preferred that the first ring 8 has a friction-enhancing coating, while the second ring 9 preferably has a friction-reducing coating.

As can be seen from FIG. 3, a third ring 11 made of plastic material is arranged between the first ring 8 and the tool 4. Similarly, a fourth ring 12 made of acrylonitrile butadiene rubber is arranged between the tool 4 and the second ring 9. The third and fourth rings are to some extent elastic elements that counteract settlement phenomena after the tool has been clamped.

FIG. 4 shows the structure again in the assembled state, with the forces acting on it also indicated; the figure thus shows the tension creation of the tool clamping. The clamping force F_{E} built up by the clamping nut 7 acts via the friction surface on the second ring 9, which here consists of a metallic body. The second ring 9 presses axially on the fourth ring 12 made of NBR (acrylonitrile butadiene rubber), which in turn presses on the grinding wheel 4. This presses the grinding wheel against the abutment flange 6 of the tool spindle 1. The first ring 8, which is coated with diamonds or CBN, and the third ring 11, which is made of plastic, are arranged between the abutment flange 6 and the grinding wheel 4.

The aim is to minimize the clamping force F_{E}. To achieve this, the friction surfaces involved in the flow of force are provided with different friction values, as explained.

The contact surfaces of the first ring 8 on the one hand on the abutment flange 6 and on the other hand on the third ring 11 have a high friction coefficient (of μ₁=0.6) due to the coating with diamond grains or CBN. The third ring 11 is pressed against the tool 4. Since the latter consists of bonded corundum particles (which can “dig” into the material of the third ring 11), this is also a largely non-rotational bond.

The opposite side has a very low friction coefficient (μ₂=0.1) at the contact surface between the clamping nut 7 and the second ring 9.

The arrows in FIG. 4 show the resulting possible uneven introduction of the operating force F_{B}. The contact surface with the higher friction coefficient can absorb larger operating forces than the contact surface with the lower friction coefficient. The low friction coefficient ensures a low contact frictional torque of the clamping nut 7, which reduces the tightening torque required to achieve the clamping force F_{E}. To determine the clamping force, all loads that occur during operation must be taken into account. In addition to the power to be transmitted, these depend on the dimensions of the clamping surfaces and the cutting forces that occur during grinding. After taking into account the various friction values, the force F_{E} can be calculated. The aim is to tighten the clamping nut 7 not by hand but with the available motor torque of the drive motor of the tool spindle 1. To do this, the clamping nut 7 is, as explained, secured against rotation while the motor is turning. This process can be fully automated.

Attention should be paid to any settling that may occur over time during production. This is particularly likely with materials of low strength. To compensate for stress peaks, a third ring 11 in the form of a thin plastic ring is placed between the grinding disc 4 and the first ring 8. Raised abrasive grains of the porous grinding tool 4 can press into this soft ring without causing local stress peaks. However, plastics have the disadvantage that they deform viscoelastically or plastically under load, i.e. they creep. The resulting change in shape causes a change in the distance between the grinding wheel 4 and the abutment flange 6 of the tool spindle 1. The consequence is a reduction in the clamping force.

To compensate for this settling effect, the second ring 9 is integrated into the tension creation, which ring is preferably made of plastic. This is comparable in function to a compression spring. When the elastomer is prestressed by tightening the clamping nut 7, a prestressing force builds up depending on the elastomer stiffness. The stiffness can be adjusted by means of the Shore hardness of the elastomer and its material thickness. The design is made in such a way that the losses of the prestressing force of the elastomer due to the expected settling distances can be compensated within the clamping force tolerance of the tool clamping.

The first ring 8 between the abutment flange 6 and the tool 4 is, as explained, preferably covered or coated with CBN (boron nitride), so that the material of the ring 8 has a significantly increased friction coefficient in contact with the respective adjacent components (abutment flange 6 or third ring 11). The second ring 9, however, consists of plastic material with a relatively low friction coefficient with respect to its neighboring components (with respect to the fourth ring 12 and the clamping nut 7). If the material of the second ring 9 has a low friction coefficient relative to the adjacent components, no further measures are required. However, it may be advantageous to provide the second ring 9 with a coating that minimizes the friction coefficient.

Care must be taken to ensure that the axial clamping of the tool relative to the tool spindle remains sufficiently rigid against the machining loads. Otherwise, the extensive absorption of setting amounts in the relatively soft rings can have a negative effect on the process.

The tightening torque applied by the drive motor of the tool spindle is distributed according to the friction situations and thread pitch. A part of the torque is applied to the thread on which the clamping nut 7 is screwed, while the other part is available as a frictional torque for pressing the clamping nut 7 axially against the second ring 9; this part of the tightening torque is thus converted into an axial force with which the tool 4 is axially clamped. A small amount of friction between the clamping nut 7 and the second ring 9, or between the second ring 9 and the fourth ring 12, allows a larger part of the tightening torque to be converted into the axial clamping force.

In the preferred application of a tool spindle 1 in the form of an internal gear generative grinding spindle, a dressable grinding tool 4 in the form of a grinding worm is used. Since in this case the tool has only a small usable or dressable volume, the productivity of internal gear generative grinding and the frequently required tool changes generally suffer.

The proposed method is particularly advantageous in this case if automatic clamping of the tool and/or automatic tightening of the clamped tool 4 is carried out by holding the clamping nut 7 with the means 10 in a rotationally fixed manner, while at the same time the drive motor of the tool spindle 1 is actuated and the clamping nut 7 is tightened/retightened as a result.

In this context, the tightening of the clamping nut is particularly important, as there is a particular risk with small tools that the clamping will come loose, which can lead to production stoppages and tool damage.

While the explained example is used preferably for internal machining by means of a grinding arm, the concept described above is of course also suitable for other applications, in particular for external machining of a profile or gearing.

Similarly, the tool spindle can ultimately be driven in any way, for example by a belt drive that runs in the grinding arm, but also by a direct drive that is connected directly to the spindle.

While specific embodiments of the invention have been shown and described in detail to illustrate the inventive principles, it will be understood that the invention may be embodied otherwise without departing from such principles.

### LIST OF REFERENCES

1 Tool spindle
2 cylindrical receiving seat
3 Thread
4 Tool (grinding worm)
5 Bore
6 Abutment flange
7 Clamping nut
8 First ring (with friction-enhancing coating)
9 Second ring (with friction-reducing coating)
10 Means for holding the clamping nut against rotation (counterholder)
11 Third ring (made of plastic)
12 Fourth ring (made of NBR)
13 Grinding arm
14 Bellows coupling
μ₁ First friction coefficient
μ₂ Second friction coefficient
F_{E} Clamping force (axial force introduced by the clamping nut)
F_{B} Operation force

We claim:

1. A method for clamping a tool on a tool spindle in a hard finishing machine, wherein the hard finishing machine comprises:
a tool spindle connected to a drive motor, with a cylindrical receiving seat and a thread, and
a tool, in particular a grinding tool, with a bore for receiving the tool on the receiving seat,
wherein the receiving seat is limited at an axial position of the tool spindle by an abutment flange for the direct or indirect axial abutment of the tool, and
wherein a clamping nut is screwable onto the thread, which is formed for direct or indirect axial abutment against the tool,
wherein means are further arranged to temporarily hold the clamping nut in a rotationally fixed manner during the rotation of the tool spindle with the drive motor,
wherein the method comprises the steps of:
a) placing the tool on the receiving seat and screwing the clamping nut onto the thread;
b) blocking the clamping nut against rotation by the means, so that the clamping nut is fixed against rotation during the rotation of the tool spindle with the drive motor;
c) actuating the drive motor and thereby tightening the clamping nutso that it presses axially against the tool.

2. The method according to claim 1, wherein it is repeated at least once during the production process, preferably periodically, with the tool clamped.

3. A hard finishing machine, in particular gear or profile grinding machine, comprising
a tool spindle connected to a drive motor and having a cylindrical receiving seat and a thread, and
a tool, in particular a grinding tool, with a bore for receiving the tool on the receiving seat,
wherein the receiving seat is limited at an axial position of the tool spindle by an abutment flange for direct or indirect axial abutment with the tool, and
wherein a clamping nut is arranged on the thread and is designed for direct or indirect axial abutment against the tool,
wherein furthermore means are provided to hold the clamping nut temporarily in a rotationally fixed manner when the tool spindle is rotated by the drive motor.

4. The hard finishing machine according to claim 3, wherein a first ring is arranged axially between the abutment flange and the tool which has a first friction coefficient between itself and the abutment flange, and in that a second ring is arranged axially between the clamping nut and the tool which has a second friction coefficient between itself and the clamping nut, the first friction coefficient being greater than the second friction coefficient.

5. The hard finishing machine according to claim 4, wherein the first friction coefficient is at least twice as large as the second friction coefficient.

6. The hard finishing machine according to claim 4, wherein the first friction coefficient is at least 0.5 and the second friction coefficient is at most 0.15.

7. The hard finishing machine according to claim 4, wherein the first ring consists of a base body which is provided with a friction-increasing coating.

8. The hard finishing machine according to claim 7, wherein the friction-increasing coating has diamond grains or boron nitride grains or is formed by these.

9. The hard finishing machine according to claim 4, wherein the second ring consists of a base body which is provided with a friction-reducing coating or the material of which, in particular plastic, has a low coefficient of friction.

10. The hard finishing machine according to claim 4, wherein a third ring made of plastic is arranged between the first ring and the tool.

11. The hard finishing machine according to claim 4, wherein a fourth ring is arranged between the second ring and the tool, which fourth ring comprises acrylonitrile-butadiene rubber or consists of this material.
